(19) United States
(12) Patent Application Publication
(10) Pub. No.: US 2014/0258433 A1
(43) Pub. Date: Sep. 11, 2014

(54) ELECTRONIC MAIL SYSTEM USING A POOL OF VALID TOKENS

(71) Applicant: Steven David CLARK, Oxfordshire (GB)

(72) Inventor: Steven David Clark, Chipping Norton (GB)

(21) Appl. No.: 14/349,270

(22) PCT Filed: Oct. 4, 2012
(86) PCT No.: PCT/GB2012/052457

§ 371 Date: Apr. 2, 2014

(30) Foreign Application Priority Data
Oct. 6, 2011 (GB) 1117262.4

(51) Int. Cl. H04L 12/58

(52) U.S. Cl. CPC H04L 51/12
USPC 709/206

(57) ABSTRACT

A system for handling email messages comprising: at an originating email server: obtaining a token from a finite pool of valid tokens associated with a sender of an email message that is to be sent to an addressee; incorporating the token into the email message; sending the email message towards its addressee; at a receiving system: inspecting an incoming email message for the presence of a token and establishing the validity of the token; and if a valid token is present, delivering the message to the addressee, and otherwise rejecting the message; or delivering the message to a primary mail box of the addressee if a valid token is present and otherwise delivering the message to a secondary mail box of the addressee; at an addressee's system: acting, responsive to an event indicative that the message is objectionable, to cause the token to be removed from the pool of valid tokens.

### CROSS-REFERENCE TO RELATED APPLICATIONS

This application is a national phase entry under 35 U.S.C. §371 of International Patent Application PCT/GB2012/052457, filed Oct. 4, 2012, designating the United States of America and published in English as International Patent Publication WO2013/050765 A1 on Apr. 11, 2013, which claims the benefit under Article 8 of the Patent Cooperation Treaty to Great Britain Application Serial No. 1117262.4, filed Oct. 6, 2011, the disclosure of each of which is hereby incorporated herein in its entirety by this reference.

### TECHNICAL FIELD

The present disclosure relates to an electronic mail (email) system. In particular, it relates to an email system that is intended to reduce the amount of unwanted messages that are received by users.

### BACKGROUND

At present, it is believed that a majority of email messages that are sent using the Internet are spam messages. This imposes a burden on operators of e-mail servers, who must provide hardware to handle a volume of messages that are at best annoying and at worst potentially harmful to their paying customers. The abundance of spam can obscure legitimate messages, and the content of spam is often offensive or potentially harmful to their computer systems.

### BRIEF SUMMARY

The root cause of spam email is that sending a message is practically free of cost for the seller. Therefore, sending spam messages can return a financial profit, even if only a very small proportion of messages sent actually yield a return.

Many systems have been proposed for classifying incoming email messages as either wanted or as spam, which can be deleted. By their nature, these will never be perfect, and they place a processing load on servers that are running them.

The present applicant has identified the need to provide a system for reducing the number of spam messages received by a user and, over time, the total number of spam messages being sent.

In accordance with a first aspect of the present disclosure, there is provided a system for handling email messages comprising:

at an originating email server:

obtaining a token from a finite pool of valid tokens associated with a sender of an email message that is to be sent to an addressee;

incorporating the token into the email message; and

sending the email message towards its addressee

at a receiving system:

inspecting an incoming email message for the presence of a token and establishing the validity of the token; and

either:

if a valid token is present, delivering the message to the addressee, and otherwise rejecting the message; or

delivering the message to a primary mail box of the addressee if a valid token is present and otherwise delivering the message to a secondary mail box of the addressee;

at an addressee's system:

acting, in response to an event indicative that the message is objectionable, to cause the token to be removed from the pool of valid tokens associated with a sender.

Thus, a message that has a valid token will be delivered to an addressee, while others will be rejected or delivered to a secondary mail box (e.g., spam mail box specifically configured to receive messages without a token or without a valid token).

The event may be a user action, such as an interaction with a GUI element on the display of a mail user agent, or the outcome of an automated analysis of the message. In either case, in the event that the recipient, or the automated system acting on behalf of the recipient, takes positive action to indicate the message was objectionable tokens will be removed from the pool of valid tokens associated with a sender. Thus, if a sender's messages are repeatedly objected to, their pool of valid tokens will become exhausted, and further email messages will be rejected by their recipients.

Preferably, the token is incorporated into the headers of the email message. This allows the token to be incorporated in a way that is transparent to a user. Alternatively or additionally, the token may be incorporated into the body of the email message, for example, encoded in HTML code.

A system embodying the disclosure most typically further includes a token server that is operative to maintain a list of valid tokens associated with a user that is authorized to send messages using the system. Advantageously, both the originating email server and the addressee's system can each communicate with the token server over a network link, which may include the Internet. The step of obtaining a token may include the originating email server sending a request to the token server and receiving a token from the token server.

The step of acting to cause the token to be removed from the pool of valid tokens associated with a sender may include the addressee's email client sending a message to the token server. This means that the user need not interact with any additional pieces of software to use the system. For example, the system may include a software component associated with an email client that can be operated by a user to cause the system to remove the token from the pool of valid tokens associated with the sender. Such a component may include an element in a graphical user interface of the email client.

Optionally, prior to inspecting an incoming email message for the presence of a token, the message is inspected to determine whether it should be accepted by default, and if this is the case, the message is delivered to the addressee. For example, a message may be determined as being accepted by default if the sender's address appears on a whitelist. This allows a recipient to choose to allow receipt of messages from a predetermined list of senders who do not subscribe to the system.

In accordance with a second aspect of the present disclosure, there is provided a method of handling email messages at an addressee's system (e.g., addressee's e-mail client or incoming email server), comprising: receiving an incoming email message from a sender incorporating a token (e.g., validated token) from a finite pool of valid tokens associated with the sender of the mail message; and acting, in response to an event indicative that the message is objectionable, to cause the token to be removed from the pool of valid tokens associated with the sender.

The event may be a user action, such as an interaction with a GUI element on the display of a mail user agent, or the outcome of an automated analysis of the message.

In one embodiment, the token is incorporated into the headers of the email message. Alternatively or additionally, the token may be incorporated into the body of the email message, for example, encoded in HTML code.

In one embodiment addressee's email system communicates with a token server that is operative to maintain a list of valid tokens associated with a user that is authorized to send messages using the system (e.g., to cause the token to be removed from the pool of valid tokens associated with the sender).

The step of acting to cause the token to be removed from the pool of valid tokens associated with a sender may include the addressee's email client sending a message to the token server.

In one embodiment, the step of acting to cause the token to be removed from the pool of valid tokens associated with a sender includes selection of an element in a graphical user interface of the email client.

In accordance with a third aspect of the present disclosure, there is provided a computer program comprising program instructions for causing a computer to perform the method of the second aspect of the present disclosure.

### BRIEF DESCRIPTION OF THE DRAWINGS

An embodiment of the disclosure will now be described in detail, by way of example, and with reference to the accompanying drawings, in which:

FIG. 1 is a block diagram of principal components involved in operation of a system embodying the disclosure;

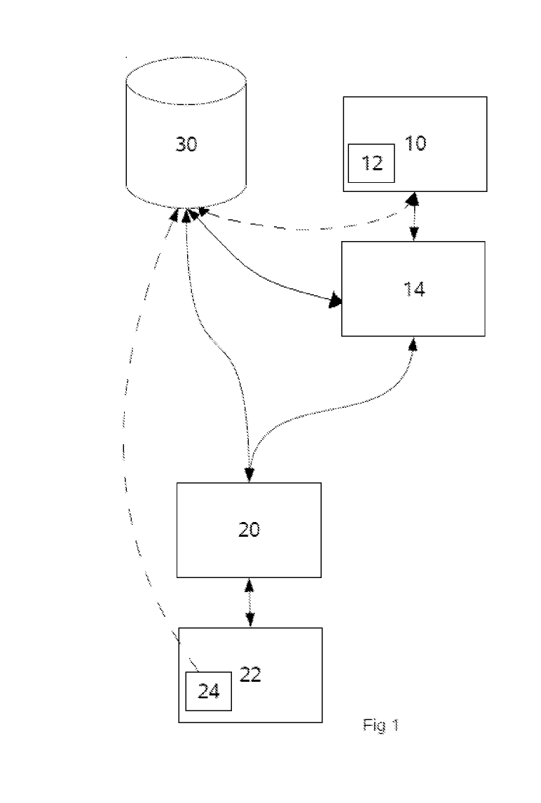

FIG. 2 is a flowchart that illustrates the procedure followed when an email message is received in an embodiment of the disclosure;

FIG. 3 is a flowchart that illustrates the procedure following delivery of an email message in an embodiment of the disclosure; and

FIG. 4 is a partial screenshot of an email client program that has been modified for use in an implementation of the disclosure;

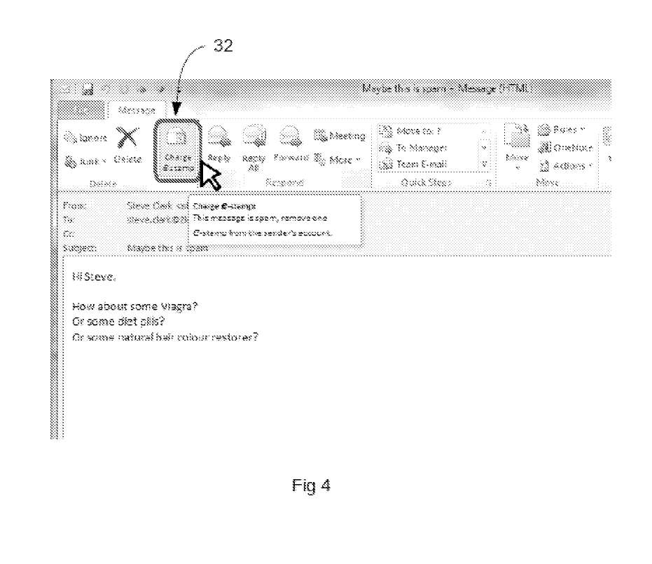

### DETAILED DESCRIPTION

For the most part, a system embodying the present disclosure resembles a conventional email system. Assume that a sender intends to send an email message to a remote recipient using the Internet as a wide-area network.

A computer system 10 from which an email message is to be sent executes an email client program 12. The email client forwards a message to an outgoing email server 14. The outgoing email server 14 is typically operated by an internet service provider (ISP) used by the sender, operating an email transport agent, which can receive and forward messages using the simple mail transport protocol (SMTP).

The outgoing email server 14 forwards the message using SMTP over the Internet to an incoming email server 20. The incoming email server 20 is typically operated by an ISP used by the recipient. It is configured to operate a mail transport agent to receive incoming messages using SMTP. Although it is possible to forward email from the incoming server direct to the recipient using SMTP, in the case of small business and personal users, it is more common for the message to be stored on the incoming server by a mail delivery agent, and allow the end-user to access the message using post office protocol (POP3) or internet mail access protocol (IMAP). In either case, the message eventually ends its journey on a computer 22 operated by or on behalf of the recipient which operates a mail user agent 24 that a user can use to view the message. The device on which the message ends its journey is not limited to any particular form of computer, and may include diverse devices such as a conventional, multi-purpose computer, a mobile device such as a smartphone, or a server computer that implements a webmail service. In many cases a user will use more than one such computer to view email messages.

Both the outgoing email server 14 and the incoming email server 20 can communicate, typically over the Internet, with a token server 30.

Overview: Sending a Message

A software plugin for the outgoing email server 14, or alternately the sender's email program 12, contacts the token server 30. The plugin identifies the user who intends to send the message and sends a request to the token server 30 for a token from that user's pool of tokens. If there is a token available, it is returned to the outgoing email server 14, or alternately the sender's email program 12, which then writes the value of the token into a header of the email message. It will be noted that ICANN RFC2822 allows for arbitrary string data to be incorporated into the headers of an email message as a so-called “optional header.” It could alternatively or additionally be incorporated into the email message body as discussed below.

Overview: Receiving a Message

As is well known, it is possible to determine the fate of an incoming email message using filters. Typically, a filter is a software object that inspects the message to determine the presence or absence of features within the message, and as a result of the inspection, causes the message to be delivered to its addressee, silently dropped, “bounced” back to the sender, or dropped and an automated response sent to the sender. These filters can be operated by the recipient's ISP, in which case they will normally operate in conjunction with the mail delivery agent. The alternative is for an end user to accept all incoming mail and apply filters before any message is placed in a user's in-box. The latter gives an end user a greater degree of control over filtering of messages, while the former allows filtering to take place transparently to the end user. Embodiments of the disclosure can operate in accordance with either of the above schemes.

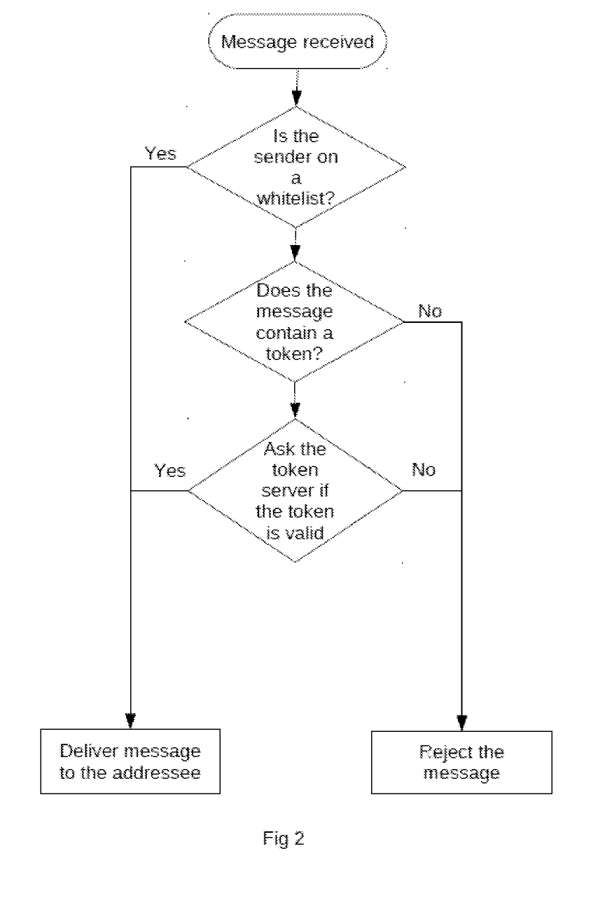

Embodiments of the disclosure filter all incoming messages by inspecting them for the presence of a token. If the token is present, the filter then checks its validity. To do this, the filter extracts the token data from the header of the email message and then contacts the token server 30 with a request to determine whether the received token is or is not valid. If a valid token is present, then the message is delivered to the addressee. Otherwise, the message is rejected. Optionally, before checking for a token, the filter may check if the address of the sender is present on a whitelist, such as the contents of an e-mail address book of the recipient, and, if it is, deliver the message without further checks being made. This process is outlined in the flowchart of FIG. 2. In an alternative embodiment, rather than rejecting the message the filter directs messages without a token or without a valid token to a secondary mail box (e.g., junk mail box specifically intended to receive messages without a valid token).

If the message is rejected for the lack of a valid token, several actions can be performed. The particular action can be configured by an administrator of the system. One option is for the message to be silently discarded. Another option is for the message to be bounced back to the sender as being undeliverable. The option that may be most preferable is to send a message back to the sender to explain why the message has not been delivered and to explain to the sender how to enroll on the system and obtain tokens of their own.

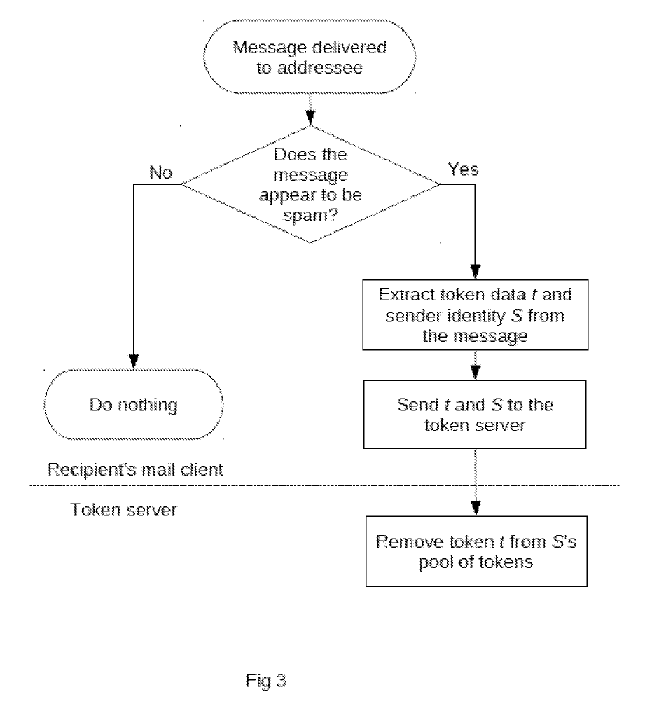

If a message is delivered to an addressee because it contains a valid token, the recipient has two options. If recipient considers the message to be valid, then no further action need be taken. However, if the recipient considers the message to be spam, then the user can perform an action that gives rise to an event to cause a charging message to be sent to the token server 30 (either direct from the recipient's email program 24 or via email server 20) that renders the present token invalid, so that it cannot be used to validate further email messages. This process is outlined in the flowchart of FIG. 3.

The event that causes the charging message to the token server may be caused by the direct action of the recipient, for example, using the user response mechanism described below, or it may be generated automatically by the mail program plugin based on an analysis of the contents of or headers of the message. This analysis can be based on criteria similar to those used by well-known spam filters, including, but not limited to, keyword matching, Bayesian filtering, blacklisting and so forth.

Implementation of the User Response Mechanism

If a user is delivered a message which, despite having a valid token, appears to the user to be spam, a mechanism must be provided whereby the user can communicate this finding to the token server with a minimum of complication and a minimum likelihood of error.

Many modern mail clients allow the use of extensions that can readily be downloaded and installed by an unskilled end user. Therefore, a preferred implementation of the user response mechanism is to provide a mail client extension that provides a button 32 on the user interface which, when clicked, will cause execution of code that will automatically generate and send the appropriate charging message to the token server 30.

An alternative implementation is to include add HTML code to the body of the message which includes a link that, when followed by a user, will cause appropriate charging data to be sent to the token server 30.

To ensure full compatibility with all email clients, the recipient may be given the alternative option of forwarding the entire message to a specific email address. Doing so will cause the message to be processed by an automated system, and the relevant data will be forwarded to the token server 30.

The Nature of a Token

A token must meet two principal requirements. First, it must be very difficult for anyone to guess to prevent forgeries. Second, it must be able to be readily incorporated into an email message. RFC2822 specifies that the content of an optional field must be an alphanumeric string. Therefore, a token that incorporates a sufficiently long alphanumeric string meets with both of these requirements. A token of this form has the further advantages that it can be incorporated into a message in a manner that is invisible to a normal user, and validation is a simple, fast computational process.

Operation of the Token Server

To use the server, an email sender must subscribe to obtain an account. The user is given an initial allocation of a number (say, 1000) of tokens. This is done be generating that number of random alphanumeric strings and storing them in a database, along with an identifier that associates them with the user's account. Since the tokens are random strings, there is no way that anyone can predict the content of tokens allocated to any given user. This means that it is essentially impossible to generate a fraudulent charging message. Only someone with access to token data attached to an actual email message can do this.

When the token server 30 receives a request for a token from a user's outgoing mail server 14, it picks one of the strings from the user's pool, and returns it to the outgoing mail server 14. Various strategies can be used to determine which token is chosen: for example, it may be that the first on the list is always chosen, they may be chosen sequentially, or they may be picked at random.

Obtaining Tokens

The main motivation for a new user to enroll in the system is that it has the potential to increase the likelihood that their messages will get through to their addressees, and thereby gain competitive advantage over others who are not enrolled. In addition, since it is likely to reduce the amount of spam and harmful mail, genuine message will appear more prominently. As these systems become adopted by end users, the likelihood that a message will reach its recipient will decline unless it contains a token.

When a user first enrolls with the system, their account is credited with an initial number (for example, 1000) of tokens. Enrollment and the initial tokens may be free of charge to the user. In view of this, safeguards must be put in place to ensure that multiple enrollments from the same person or company are prevented, for example, by using technical means to identify the origin of an application.

Provided that messages sent by a user are not objected to by their recipients, their pool of tokens will remain constant. Tokens are removed only in response to a complaint from a recipient. It is inevitable, over time, that a sender's message will receive objections, and their stock of tokens will diminish. The rate at which this happens is, of course, directly related to the rate at which the messages sent are deemed to be objectionable by their recipients.

Once a user's supply of tokens is nearing exhaustion, the user will be given the opportunity to obtain more. A key feature of this step is that more tokens cannot simply be obtained at will—some form of cost is incurred. For instance, a user may be limited in the total number of tokens that they can obtain in a given time, and/or they may be able to obtain more tokens only in return for a financial payment. The cost (financial or otherwise) can be set at a rate that is sufficiently low so as not to deter legitimate mailings, in which a reasonable rate of response is expected. However, it can render unviable any highly speculative bulk messaging, where only a tiny response rate is expected.

Typically, a user will obtain additional tokens by making a payment to the operator of the token server. In this way, the system can generate revenue for its operator. The amount that a user is required to pay can be dependent upon the user concerned. For example, a large corporate user may be offered tokens at a low rate to help to draw attention of their customers to the existence of the system.

Additional Features

A sudden increase in the rate at which a user's stamps are being consumed can indicate that their e-mail system has been compromised. The token server 30 can be configured such that, if such a situation is detected, all of a user's tokens are temporarily revoked until the problem is addressed.

In one embodiment, a user's stamp may additionally be used as a form of micropayment for other services (e.g., services other than the sending of an email). In this case, the fiscal value of the stamp may be refunded in whole or part to the recipient.

The outgoing mail server 14 could include a virus or malware filter to check messages before attaching a token. This can give a recipient of a message greater confidence that the message will be safe to open.

Messages with tokens can only originate from authorized mail servers. This makes these messages easily differentiable from bulk spam which is often sent directly onto the internet without the use of POP or IMAP servers.

Since the token is issued by a central token server, which validates the sender's address, a message carrying a token is guaranteed to have genuinely originated from the address in the header. Currently emails can easily be forged, and have no guarantee of provenance or traceability.

1. A system for handling email messages comprising:
at an originating email server:
obtaining a token from a finite pool of valid tokens associated with a sender of an email message that is to be sent to an addressee;
incorporating the token into the email message; and
sending the email message towards its addressee
at a receiving system:
inspecting an incoming email message for the presence of a token and establishing the validity of the token; and
either:
if a valid token is present, delivering the message to the addressee, and otherwise rejecting the message; or
delivering the message to a primary mail box of the addressee if a valid token is present and otherwise delivering the message to a secondary mail box of the addressee;
at an addressee's system:
acting, in response to an event indicative that the message is objectionable, to cause the token to be removed from the pool of valid tokens associated with the sender.

2. A system according to claim 1 in which the event is a user action.

3. A system according to claim 1 in which the event is the outcome of an automated analysis of the message.

4. A system according to claim 1 in which the token is incorporated into the headers of an email message.

5. A system according to claim 1 in which the token is incorporated into the body of an email message.

6. A system according to claim 5 in which the token is encoded in HTML code.

7. A system according to claim 1 that further includes a token server that is operative to maintain a list of valid tokens associated with a user that is authorized to send messages using the system.

8. A system according to claim 7 in which the originating email server and the addressee's system can each communicate with the token server over a network link.

9. A system according to claim 7 in which the step of obtaining a token includes the originating email server sending a request to the token server and receiving a token from the token server.

10. A system according to claim 7 in which the step of acting to cause the token to be removed from the pool of valid tokens associated with a sender includes the addressee's email client sending a message to the token server.

11. A system according to claim 1 that further includes a software component associated with an email client that can be operated by a user to cause the system to remove the token from the pool of valid tokens associated with the sender.

12. A system according to claim 11 in which the software component includes an element in a graphical user interface of the email client.

13. A system according to claim 1 in which, prior to inspecting an incoming email message for the presence of a token, the message is inspected to determine whether it should be accepted by default, and if this is the case, the message is delivered to the addressee.

14. A system according to claim 13 in which the message is determined as being accepted by default if the sender's address appears on a whitelist.

15. A method of handling email messages at an addressee's system, comprising:
receiving an incoming email message from a sender incorporating a token from a finite pool of valid tokens associated with the sender of the mail message; and
acting, in response to an event indicative that the message is objectionable, to cause the token to be removed from the pool of valid tokens associated with the sender.

16. A computer program comprising program instructions for causing a computer to perform the method of claim 15.
